(19) United States
(12) Patent Application Publication
(10) Pub. No.: US 2007/0280300 A1
(43) Pub. Date: Dec. 6, 2007

(54) METHOD OF POWER STATE SYNCHRONIZATION AND RELATED DEVICE

(76) Inventor: CHIH-LIN HU, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/735,502

(22) Filed: Apr. 16, 2007

(30) Foreign Application Priority Data
Apr. 17, 2006 (TW) 095113664

(51) Int. Cl. H04J 3/06

(52) U.S. Cl. 370/503

(57) ABSTRACT

A method of power state synchronization is applied to network terminals in a network. A first network terminal enters an active state from a rest state, and the first network terminal broadcasts a first notice signal. A second network terminal examines a second record table of the second network terminal, and adds the power state of the first network terminal to the second record table of the second network terminal if the second record table has no data of the first network terminal. Then, the second network terminal sends a second notice signal to the first network terminal after receiving the first notice signal. Finally, the first network terminal updates a first record table of the first network terminal.

### BACKGROUND OF THE INVENTION

1. Field of the Invention

The prevent invention is related to a method of power state synchronization, and more particularly, to a method of power state synchronization with commands according to a Simple Service Discovery Protocol (SSDP), a Simple Object Access Protocol (SOAP), and a General Event Notification Architecture (GENA).

2. Description of the Prior Art

Universal plug and play (UPnP) is a point-to-point network connection architecture for computers, smart devices, and wireless devices. In addition to transmitting and controlling data between homes, offices, and any other places, this open network connection architecture can connect to the Internet through the TCP/IP protocol.

UPnP includes a series of standards and related comprehensive items established by the UPnP Forum. The UPnP architecture includes two device functions: a control point and a power management (PM) device. Any device can have one or both functions. The control point and the PM device work with a set of UPnP network operations, such as search, discovery, description, control, eventing and presentation.

Please refer to FIG. 1. FIG. 1 is a diagram of an UPnP power management system 10. The UPnP power management system 10 includes a plurality of network terminals 12, 13, 14, 15A, 15B, 15C. The network terminal 12 includes a control point, which works as a client in the network. The network terminal 13 and the network terminal 14 include a power management device and a power management application, which work as a server in the network. The network terminals 15A, 15B, 15C each include a control point, a power management device, and a power management application. The network terminals 15A, 15B, 15C are hybrid PM nodes, which can work as both a client and a server in the network. The power management device has a Wake-On-LAN function. When the power state changes, the control point will subscribe to and notify the power management that the power state has been changed. In addition, the control point can control the change of the power management device. The power state can be divided into an active state and a rest state. The rest state can be a sleep state or a power-off state.

Please refer to FIG. 2. FIG. 2 is a diagram of the power state mentioned above. As shown in FIG. 2, there are five network terminals 21-25 in the network. The network terminals 21-25 are hybrid PM nodes. The network terminals 21-25 include record tables S1-S5, respectively. The record tables S1-S5 store a list of the network terminals in the network that are in the active state. When the network terminals 21-25 are originally in the active state, the contents of the record tables S1-S5 are 1, 2, 3, 4, and 5.

Please refer to FIG. 3. FIG. 3 is a diagram of synchronous update of the power states according to the prior art. As shown in FIG. 3, there are five network terminals 21-25 (corresponding to FIG. 2). Each of the network terminals 21-25 includes the record tables S1-S5. The network terminals 21-25 are originally in the active state, and the contents of the record tables S1-S5 are 1, 2, 3, 4, and 5. If the network terminal 23 enters the rest state, the network terminal 23 will send a goodbye signal to other network terminals, and the record tables S1, S2, S4, and S5 will update their contents to 1, 2, 4, and 5. Because the network terminal 23 enters the rest state, the record table S3 cannot be updated, thus remaining as 1, 2, 3, 4, and 5. At this time, if the network terminal 25 also enters the rest state, the network terminal 25 will send a goodbye signal to the other network terminals, and the record tables S1, S2, and S4 will update their contents to 1, 2, and 4. Because the network terminal 25 enters the rest state, the record table S5 cannot be updated, thus remaining as 1, 2, 4, and 5. When the network terminal 23 enters the active state from the rest state, the network terminal 23 sends a hello signal to the other network terminals according to the record table S3, so that the network terminals 21, 22, 24 in the active state will update the contents of their record tables S1, S2, S4 to 1, 2, 3, and 4. Then, the network terminal 23 will send a synchronize request for restoring a database to the active state, and update the contents of the record table S3 to 1, 2, 3, and 4 (the record table S3 will be updated to 1, 2, 3, and 4 from 1, 2, 3, 4, and 5 after receiving the synchronize signal), so as to synchronize all of the network terminals.

Please refer to FIG. 4. FIG. 4 is a diagram of asynchronous update of the power states according to the prior art. As shown in FIG. 3, there are five network terminals 21-25 (corresponding to FIG. 2). The network terminals 21-25 include record tables S1-S5 respectively. Suppose there are four network terminals 22-25 originally in the active state in the network. When the network terminal 23 enters the rest state from the active state, the network terminal 23 sends a goodbye signal to the other network terminals. At this time, the contents of the record table S3 are 2, 3, 4, and 5, and the contents of the record tables S2, S4, and S5 are updated to 2, 4, and 5. If the network terminal 25 also enters the rest state, the network terminal 25 sends a goodbye signal to the other network terminals according to the contents of the record table S5. At this time, the contents of the record tables S2 and S4 are updated to 2 and 4, and the contents of the record table S5 remain at 2, 4, and 5. If the network terminal 21 joins the network, the network terminal 21 will broadcast an alive signal to the network. At this time, only the network terminals 22, 24 in the active state can receive the alive signal. The network terminals 22, 24 send a register signal to the network terminal 21 and the contents of the record tables S1, S2, S4 are updated to 1, 2, and 4. When the network terminal 25 enters the active state again, the network terminal 25 sends a hello signal to the network terminals 22, 24 according to the record table S5, and broadcasts an alive signal to the network terminals 21, 22, 24, 25 in the active state. When the network terminal 21 detects the network terminal 25, the network terminal 21 sends a register signal to the network terminal 25. Then, the network terminal 25 sends a synchronize signal for restoring the database to the active state for updating the contents of all of the record tables (S2, S3, S5) to 2, 4, and 5. At this time, the network terminal 25 may not receive the register signal from the network terminal 21 because of network or processor delay. Therefore, it is found that the contents of the record tables S1, S2, S4, S5 deviate from actual asynchronous power states.

As mentioned above, if the alive signal, the hello signal, the register signal, and the synchronize signal are sent in a different sequence, it may cause asynchronous power states.

Each network terminal in the network can select freely when to be in the rest state or in the active state, and the record table stored in the database for saving the power states of the network terminals in the active state is updated as the power states of the network terminals change. However, the method for power state synchronization according to the prior art cannot synchronize the power states in some situations because the alive signal, the hello signal, the register signal, and the synchronize signal may be sent in different sequences.

### SUMMARY OF THE INVENTION

The present invention provides a method for power state synchronization applied to a plurality of network terminals in a network, each network terminal selected to be in a rest state or an active state and having a record table for storing a power state of the network terminals in the network, the method comprising enabling a first network terminal to enter the active state from the rest state; broadcasting a first notice signal in the network by the first network terminal; examining a second record table of a second network terminal after the second network terminal receives the first notice signal; when the second record table has no data corresponding to the first network terminal, adding the state of the first network terminal to the second record table of the second network terminal and sending a second notice signal to the first network terminal; and updating a first record table of the first network terminal by the first network terminal.

The present invention provides a network terminal in a rest state or a active state in a network having a plurality of network terminals, comprising a memory for storing a record table saving the plurality of network terminals in the active state in the network; a transmitting device; a receiving device; and a processor for driving the transmitting device to broadcast a first notice signal to the network when the network terminal enters the active state from the rest state; wherein a second network terminal in the network receives the first notice and sends a second notice signal to the network terminal, the receiving device receives the second notice signal, and the record table is updated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an UPnP power management system according to the prior art.

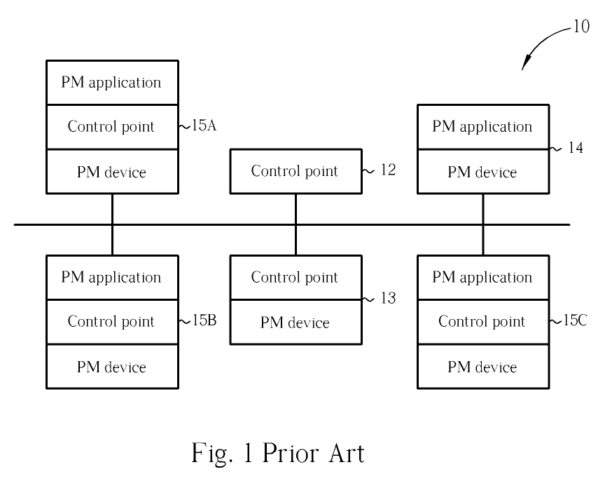

FIG. 2 is a diagram of power states according to the prior art.

FIG. 3 is a diagram of a synchronous update of the power states according to the prior art.

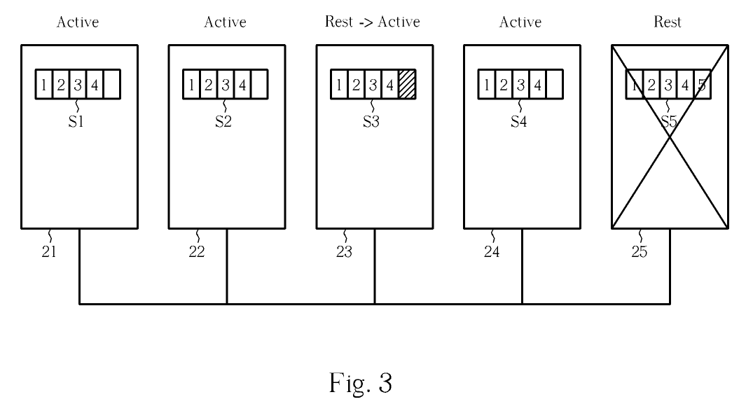

FIG. 4 is a diagram of an asynchronous update of the power states according to the prior art.

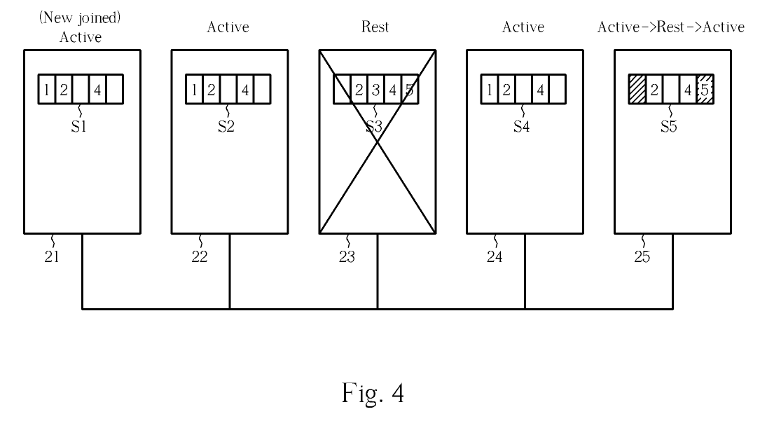

FIG. 5 is a diagram of an embodiment for restoring power state synchronization according to the present invention.

FIG. 6 is a flowchart of a method of power state synchronization according to the present invention.

### DETAILED DESCRIPTION

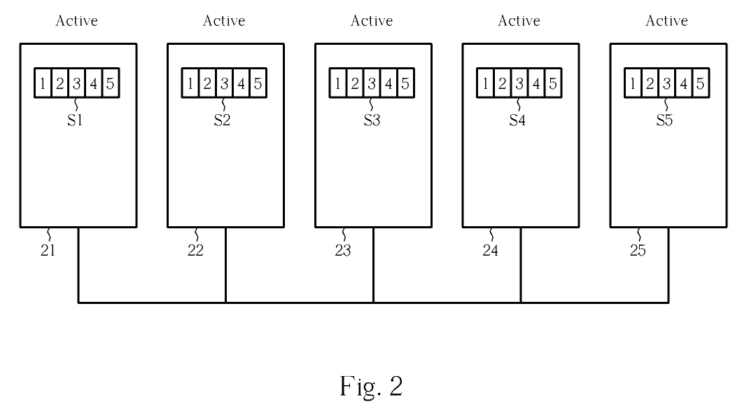

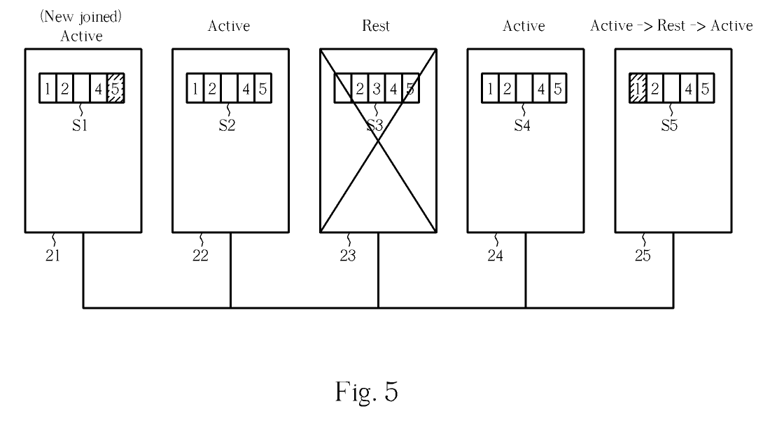

FIG. 5 is a diagram of an embodiment for restoring power state synchronization according to the present invention. As shown in FIG. 5, there are five network terminals 21-25 in the network (equivalent to FIG. 2). The network terminals 21-25 include record tables S1-S5 respectively. Suppose the network terminals 22-25 are originally in the active state, and the network terminal 23 is in the rest state. The network terminal 23 sends a goodbye signal to other network terminals, and the contents of the record table S3 are 2, 3, 4, and 5. The contents of the record tables S2, S4, S5 are updated to 2, 4, and 5. If the network terminal 25 enters the rest state, the network terminal 25 will send a goodbye signal to the other network terminals. Thus, the contents of the record tables S2, S4 are updated to 2 and 4, and the contents of the record table S5 keep 2, 4, and 5.

Sometimes, the network terminal 25 leaves the network because of a suddenly power disconnect, so the network terminal 25 will not send a goodbye signal to the other network terminals, and the contents of the record tables S2, S4, S5 will keep 2, 4, and 5. If the network terminal 21 joins at this time, because the network terminal 22, 24 are in the active state, the network terminal 21 will send an alive signal to the network terminals 22, 24 and then the network terminals 22, 24 will send a register signal to the network terminal 21 again. The contents of the record tables S1, S2, S4 are updated to 1, 2, and 4 (or the contents of the record table S1 is updated to 1, 2, and 4, and the contents of the record tables S2, S4 are updated to 1, 2, 4, and 5). If the network terminal 25 enters the active state again, the network terminal 25 will broadcast an alive signal to the other network terminals 21, 22, 24 in the active state. When the network terminals 21, 22, 24 receive the alive signal from the network terminal 25, the network terminals 21, 22, 24 examine whether the contents of the record tables S1, S2, S4 have data of the power state of the network terminal 25. The network terminal 21 has no data of the power state of the network terminal 25, the network terminal 21 will send a register signal to the network terminal 25, and the contents of the record table S1 will be updated to 1, 2, 4, and 5. The record tables S2, S4 of the network terminals 22, 24 have data of the power state of the network terminal 25, the network terminals 22, 24 will update the record tables S2, S4 and will not send the register signal. Then the network terminal 25 sends a hello signal to the other network terminals 21, 22, 24 in the active state according to the contents of the record table S5, and the contents of the record tables S1, S2, S4 are updated to 1, 2, 4, and 5. Finally, the network terminal 25 sends a syncPMDB signal to the network terminals 21, 22, 24, and updates the contents of the record table S5 to 1, 2, 4, and 5. Therefore, the contents of the record tables S1, S2, S4, S5 of the network terminals 21, 22, 24, 25 in the active state are 1, 2, 4, and 5, so the database synchronization is ensured.

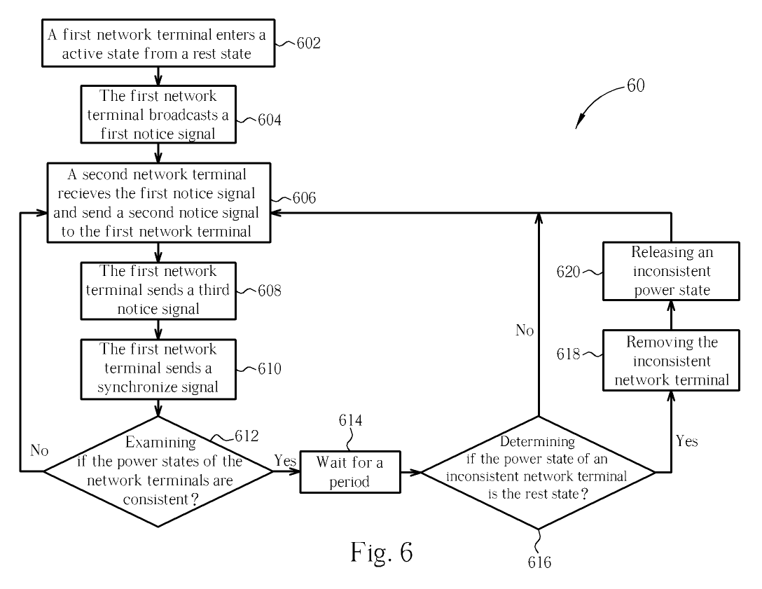

Please refer to FIG. 6. FIG. 6 is a flowchart of a method of performing power state synchronization according to the present invention. The procedure 60 according to the present invention includes the following steps:

Step 602: A first network terminal enters the active state from the rest state.

Step 604: The first network terminal broadcasts a first notice signal.

Step 606: A second network terminal receives the first notice signal. The second network terminal updates a second record table, and selectively sends a second notice signal to the first network terminal according to the second record table. The first network terminal updates a first record table. The second network terminal determines whether to send the second notice signal according to whether the contents of the second record table have data of the power state of the first network terminal. If the second record table has no data of the power state of the first network terminal, the second network terminal sends the second notice signal. If the second record table has the data of the power state of the first network terminal, the second network terminal updates the contents of the second record table and does not send the second notice signal.

Step 608: The first network terminal sends a third notice signal to the network terminals in the active state according to the first record table.

Step 610: The first network terminal sends a synchronize signal for restoring a database, and updates the first record table.

Step 612: The power states of the network terminals are examined to determine if they are consistent. If so, go to step 614. If not, go to step 606.

Step 614: Waiting a predetermined time period of time.

Step 616: If the power state of an inconsistent network terminal is the rest state, go to step 618. If not, go to step 606.

Step 618: The inconsistent network terminal is removed from the network.

Step 620: An inconsistent power state corresponding to the inconsistent network terminal is released.

Step 602 includes two conditions: a sleep state, and a power-off state. In Step 604, the first network terminal broadcasting the first notice signal is broadcasting an alive signal according to a Simple Service Discovery Protocol (SSDP). In Step 606, the second network terminal sending the second notice signal is subscribing to the first network terminal according to the Simple Service Discovery Protocol (SSDP). At this time, the second network terminal updates the power state of the network terminal in the active state in the network in the second table. In Step 608, the first network terminal sending a third notice signal is sending a hello signal to the network terminals in the active state in the network according to a General Event Notification Architecture (GENA). In Step 610, the first network terminal sending a synchronize signal for restoring the database is sending a syncPMDB signal to the other network terminals according to a Simple Object Access Protocol (SOAP). At this time, the first network terminal updates the power state of the network terminal in the active state in the network in the first table.

The embodiment as mentioned above is only for illustration, and does not restrict the present invention. For example, the first network terminal entering the active state from the rest state includes the first network terminal waking up from the rest state or the first network terminal joining the network. As long as the notice signal is sent and the record table is updated according to the procedure 60 to synchronize the database, this is covered in the present invention.

In summary, the present invention provides a method for power state synchronization. When the first network terminal wakes up from the rest state or joins the network, the first network terminal broadcasts the first notice signal (the alive signal) according to the Simple Service Discovery Protocol (SSDP). When the second network terminal receives the first notice signal according to the SSDP, the second network terminal replies with the second notice signal (the register signal) to the first network terminal and updates the second record table. Then, the first network terminal sends the third notice signal (the hello signal) according to the General Event Notification Architecture (GENA). Finally, the first network terminal sends the synchronize signal (the syncPMDB signal) for restoring the database according to the Simple Object Access Protocol (SOAP) and updates the first record table. So, following the procedure 60 can synchronize the database. In addition, the method according to the prevent invention does not require modification of stacks in the current UPnP protocol, and is compatible with general power management devices, so the present invention is easy to implement.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for power state synchronization applied to a plurality of network terminals in a network, each network terminal being selectively in a rest state and an active state and having a record table for saving a power state of the network terminals in the network, the method comprising:
enabling a first network terminal from the rest state to the active state;
broadcasting a first notice signal in the network by the first network terminal;
examining a second record table of a second network terminal after the second network terminal receives the first notice signal;
adding the state of the first network terminal to the second record table of the second network terminal and sending a second notice signal to the first network terminal when the second record table has no data corresponding to the first network terminal; and
updating a first record table of the first network terminal by the first network terminal.

2. The method of claim 1, wherein enabling the first network terminal from the rest state to the active state is enabling the first network terminal from a sleep state to the active state.

3. The method of claim 1, wherein enabling the first network terminal from the rest state to the active state is enabling the first network terminal from a power-off state to the active state.

4. The method of claim 1 further comprising:
sending a third notice signal to the network terminals in the active state according to the first record table of the first terminal.

5. The method of claim 4, wherein sending the third notice signal to the network terminals in the active state according to the first record table of the first terminal is sending a hello signal to the network terminals in the active state according to a General Event Notification Architecture (GENA).

6. The method of claim 1 further comprising:
sending a synchronize signal of restoring a database to an active state to other network terminals by the first network terminal.

7. The method of claim 6, wherein sending the synchronize signal of restoring the database to the active state to other network terminals by the first network terminal is sending a syncPMDB signal according to a Simple Object Access Protocol (SOAP) to the other network terminals by the first network terminal.

8. The method of claim 1, wherein broadcasting the first notice signal in the network by the first network terminal is broadcasting an alive signal according to a Simple Service Discovery Protocol (SSDP) in the network by the first network terminal.

9. The method of claim 1, wherein adding the state of the first network terminal into the second record table of the second network terminal and sending the second notice signal to the first network terminal is the second network terminal updating the second record table of the second network terminal and subscribing to the first network terminal.

10. The method of claim 9, wherein the second network terminal subscribing to the first network terminal is the second network terminal subscribing to the first network according to the Simple Service Discovery protocol (SSDP).

11. The method of claim 1 further comprising:
examining if the power states of the network terminals are consistent;
determining if the power state of an inconsistent network terminal is the rest state;
removing the inconsistent network terminal from the network when the inconsistent network terminal is in the rest state; and
releasing an inconsistent power state corresponding to the inconsistent network terminal.

12. The method of claim 1, wherein adding the state of the first network terminal into the second record table of the second network terminal is the second network terminal updating the power states of the network terminals in the active state in the network.

13. The method of claim 1, wherein updating the first record table of the first network terminal by the first network terminal is the first network terminal updating the power state of the network terminals in the active state in the network.

14. The method of claim 1 further comprising:
examining a third record table of a third network terminal after the third network terminal receives the first notice signal, and when the state of the first network terminal of the third record table is the rest state, updating the state of the first network terminal.

15. A network terminal in a network, the network having a plurality of network terminals, each network terminal being selectively in a rest state and an active state, the net work terminal comprising:
a memory for storing a record table to save the plurality of network terminals in the active state in the network;
a transmitting device;
a receiving device; and
a processor for driving the transmitting device to broadcast a first notice signal to the network when the network terminal enters the active state from the rest state;
wherein a second network terminal in the network receives the first notice and selectively sends a second notice signal to the network terminal, the receiving device receives the second notice signal, and the record table is updated.

16. The network terminal of claim 15, wherein the processor drives the transmitting device to send a third notice signal to the network terminals in the active state in the network after the receiving device receives the second notice signal.

17. The network terminal of claim 15, wherein the processor drives the sending device to send a synchronize signal of restoring a database to an active state to other network terminals after the transmitting device transmits the third notice signal.

18. The network terminal of claim 15, wherein the network terminal is a power management (PM) device.

19. The network terminal of claim 15, wherein the network terminal is a Hybrid PM Node.

20. The network terminal of claim 15, wherein the second network terminal examines a second record table of the second network terminal, and when the second table has no data corresponding to the first network terminal, the second network terminal adds the state of the first network terminal to the second record table and transmits the second notice signal to the first network terminal.

21. The network terminal of claim 15, wherein the second network terminal examines a second record table of the second network terminal, and when the state of the network terminal of the second record table is the rest state, the second network terminal changes the state of the network terminal of the second record table to the active state and not transmits the second notice signal to the first network terminal.
